(19) United States
(12) Patent Application Publication
(10) Pub. No.: US 2021/0178986 A1
(43) Pub. Date: Jun. 17, 2021

(54) SYSTEM AND METHOD FOR CAPTURING AND DISPLAYING IMAGES FROM A VEHICLE/TRAILER CAMERA

(71) Applicant: GENTEX CORPORATION, Zeeland, MI (US)

(72) Inventors: David M. Falb, Grand Rapids, MI (US); Thomas E. Humbert, Zeeland, MI (US); Leah R. Hoffmeyer, Holland, MI (US); Bradley A. Bosma, Hudsonville, MI (US); Ethan J. Lee, Byron Center, MI (US)

(73) Assignee: GENTEX CORPORATION, Zeeland, MI (US)

(21) Appl. No.: 17/125,395

(22) Filed: Dec. 17, 2020

Related U.S. Application Data
(60) Provisional application No. 62/948,962, filed on Dec. 17, 2019.
(60) Provisional application No. 63/021,911, filed on May 8, 2020.

(51) Int. Cl. B60R 11/04; B60R 11/02

(52) U.S. Cl. CPC B60R 11/04; B60R 2011/0033; B60R 11/0229

(57) ABSTRACT

An imaging and display system for use in a vehicle pulling a trailer, the system including: a trailer camera mounted on the trailer such that the camera is oriented to receive images from a first field of view having a horizontal angle and a vertical angle where the vertical angle is greater than the horizontal angle; an image processor for creating a back-up image and a rearward image from an image captured by the camera, the back-up image corresponding to a second field of view cropped from the lowest portion of the first field of view and the rearward image corresponding to a third field of view cropped from a portion of the first field of view above the lowest portion, the third field of view having a horizontal angle and a vertical angle where the horizontal angle is greater than the vertical angle.

### CROSS-REFERENCE TO RELATED APPLICATIONS

This application claims priority under U.S.C. § 119(e) to U.S. provisional Application No. 62/948,962 filed on Dec. 17, 2019, entitled “SYSTEM AND METHOD FOR CAPTURING AND DISPLAYING IMAGES FROM A VEHICLE/TRAILER CAMERA,” and U.S. provisional Application No. 63/021,911 filed on May 8, 2020, entitled “SYSTEM AND METHOD FOR CAPTURING AND DISPLAYING IMAGES FROM A VEHICLE/TRAILER CAMERA,” the disclosures of which are hereby incorporated by reference in their entireties.

### FIELD OF THE INVENTION

The present invention generally relates to an imaging system for a vehicle and/or a trailer and, more particularly, an imaging and display system for use in a vehicle that may be pulling a trailer.

### BACKGROUND OF THE INVENTION

Systems are known in which a camera is mounted to the rear of a trailer to provide rearward images for display to the driver using a display device mounted in the vehicle. Such cameras typically have a field of view with an aspect ratio of about 2:1 thereby yielding a wide view of about 135 degrees horizontally and about 70 degrees vertically. This low vertical angle can result in failure to see objects close behind the trailer, particularly when the camera is mounted high up on the trailer.

### SUMMARY OF THE INVENTION

According to one aspect of the present invention, an imaging and display system is provided for use in a vehicle pulling a trailer comprising: a trailer camera mounted on the trailer such that the trailer camera is oriented to receive images from a first field of view having a horizontal angle and a vertical angle where the vertical angle is greater than the horizontal angle; an image processor for receiving the images from the trailer camera and for processing the images to create a back-up image and a rearward image from an image captured by the trailer camera, the back-up image corresponding to a second field of view cropped from the lowest portion of the first field of view and the rearward image corresponding to a third field of view cropped from a portion of the first field of view above the lowest portion, the third field of view having a horizontal angle and a vertical angle where the horizontal angle is greater than the vertical angle; and a display mounted in the vehicle and coupled to the image processor for displaying at least one of the rearward image, the back-up image, and both the rearward and back-up images. In some embodiments, the trailer camera may be configured to wirelessly transmit images to the vehicle. In some embodiments, the horizontal angle of the first field of view may be about 70 degrees and/or the vertical angle of the first field of view may be about 135 degrees. In some embodiments, the aspect ration of the first field of view may be about 9:16. In some embodiments, the horizontal angle of the second field of view may be about 70 degrees and/or the vertical angle of the second field of view may be about 67 degrees. In some embodiments, the aspect ratio of the second field of view may be about 1:1. In some embodiments, the horizontal angle of the third field of view may be about 70 degrees and/or the vertical angle of the third field of view may be about 15 degrees. In some embodiments, the aspect ratio of the third field of view may be at least about 4:1. In some embodiments, the display may be mounted in a rearview assembly mounted to one of a windshield and a roof of the vehicle. In some embodiments, the image processor may control the display to display both the rearward image and the back-up image when the vehicle is in reverse gear and to display the rearward image when the vehicle is not in reverse gear.

According to another aspect of the present invention, an imaging system is provided for a trailer comprising: a trailer camera mounted on the trailer such that the trailer camera is oriented to receive images from a first field of view having a horizontal angle and a vertical angle where the vertical angle is greater than the horizontal angle; and an image processor for receiving the images from the trailer camera and for processing the images to create a back-up image and a rearward image from an image captured by the trailer camera, the back-up image corresponding to a second field of view cropped from the lowest portion of the first field of view and the rearward image corresponding to a third field of view cropped from a portion of the first field of view above the lowest portion, the third field of view having a horizontal angle and a vertical angle where the horizontal angle is greater than the vertical angle.

According to another aspect of the present invention, an imaging and display system is provided for a vehicle comprising: a camera mounted such that the camera is oriented to receive first images from a first field of view having a horizontal angle and a vertical angle and having an aspect ratio of about 9:16; and an image processor for receiving the first images from the camera and for processing the first images to create a second image and a third image from a first image captured by the camera, the second image corresponding to a second field of view cropped from a lower portion of the first field of view and the second image corresponding to a third field of view cropped from a portion of the first field of view above the lower portion; and a display mounted in the vehicle and coupled to the image processor for simultaneously displaying both the second and third images. In some embodiments, the camera may be a trailer camera that is configured to wirelessly transmit images to the vehicle. In some embodiments, the vehicle may be a pickup truck having a truck bed and the third images are rearward images. In some embodiments, the second images may be truck bed images. In some embodiments, the horizontal angle of the first field of view may be about 70 degrees and/or the vertical angle of the first field of view may be about 135 degrees.

According to another aspect of the present invention, an imaging and display system is provided for a pickup truck having a truck bed, the system comprising: a camera mounted on the truck such that the camera is oriented to receive images from a first field of view having a horizontal angle and a vertical angle where the vertical angle is greater than the horizontal angle; an image processor for receiving images from the camera and for processing the images to create a truck bed image and a rearward image from an image captured by the camera, the truck bed image corresponding to a second field of view cropped from the lowest portion of the first field of view and the rearward image corresponding to a third field of view cropped from a portion of the first field of view above the lowest portion, the third field of view having a horizontal angle and a vertical angle where the horizontal angle is greater than the vertical angle; and a display mounted in the truck and coupled to the image processor for displaying at least one of the rearward image, the truck bed image, and both the rearward and truck bed images. In some embodiments, the horizontal angle of the first field of view may be about 70 degrees and/or the vertical angle of the first field of view may be about 135 degrees. In some embodiments, the aspect ratio of the second field of view may be about 1:1. In some embodiments, the horizontal angle of the third field of view may be about 70 degrees and/or the vertical angle of the third field of view may be about 15 degrees.

These and other features, advantages, and objects of the present invention will be further understood and appreciated by those skilled in the art by reference to the following specification, claims, and appended drawings.

### BRIEF DESCRIPTION OF THE DRAWINGS

The present invention will become more fully understood from the detailed description and the accompanying drawings, wherein:

FIG. 1 is a side view of a vehicle and trailer incorporating an imaging and display system;

FIG. 2 is a top view of the vehicle and trailer of FIG. 1;

FIG. 3 is an electrical circuit diagram in block form of the imaging and display system used in FIGS. 1 and 2;

FIG. 4 is a schematic representation of a display and an image sensor used in the imaging and display system shown in FIGS. 1-3 showing the display when the vehicle is in reverse gear;

FIG. 5 is a schematic representation of a display and an image sensor used in the imaging and display system shown in FIGS. 1-4 showing the display when the vehicle is not in reverse gear; and

FIG. 6 is a side view of a vehicle in the form of a pickup truck incorporating the imaging and display system.

### DETAILED DESCRIPTION OF THE EMBODIMENTS

The present illustrated embodiments reside primarily in combinations of method steps and apparatus components related to an imaging and display system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

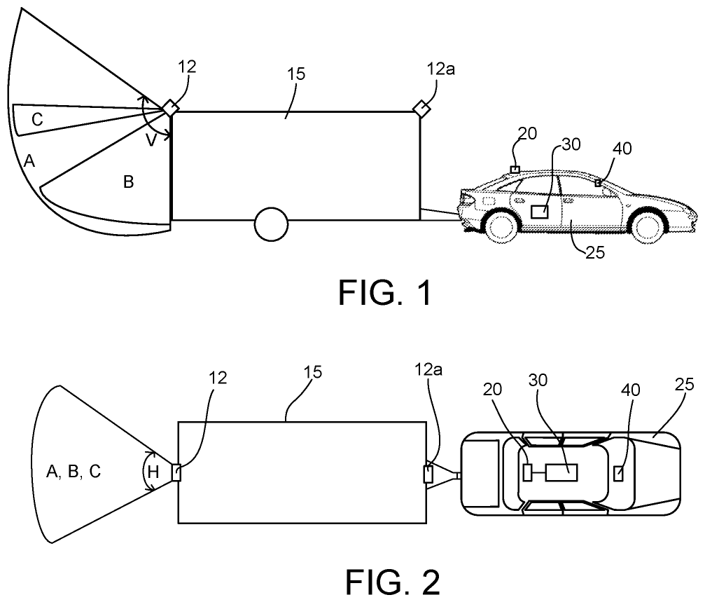

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

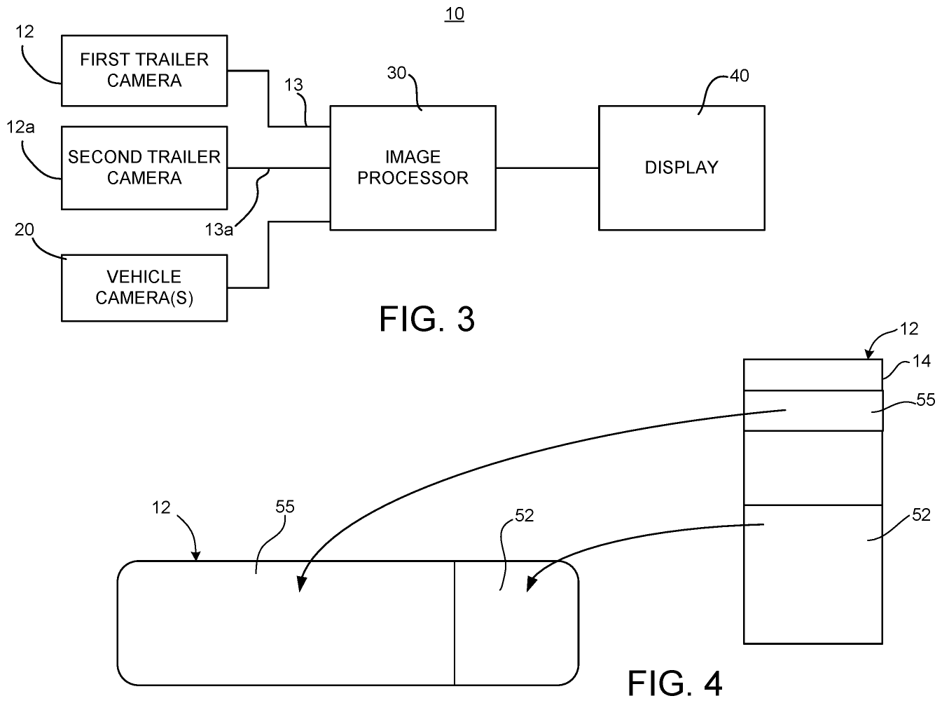

FIGS. 1-5 show an example of an image and display system 10 as well as a vehicle 25 and trailer 15 in which the system 10 may be implemented. As shown, the system 10 may include a first trailer camera 12 mounted on the trailer 15, an image processor 30 for receiving first images from the first trailer camera 12 and for processing the first images to create a back-up (or second) image 52 and a rearward (or third) image 55 from each first image captured by the first trailer camera 12, and a display 40 mounted in the vehicle 25 and coupled to the image processor 30 for displaying at least one of the rearward image 55, the back-up image 52, and both the rearward and back-up images 55 and 52.

With reference to FIGS. 1 and 2, the first trailer camera 12 may be mounted to the trailer 15 such that the first trailer camera 12 is oriented to receive images from a first field of view A having a horizontal angle H and a vertical angle V where the vertical angle V is greater than the horizontal angle H. The first trailer camera 12 may be a conventional camera that is rotated 90 degrees so as to obtain this first field of view A. The first trailer camera 12 may also be aimed downward such that the lowest part of the first field of view A includes a rear bumper of the trailer 15 and extends upward from the bumper of the trailer 15. With reference to FIG. 4, the image sensor 14 may include, for example, 2048 rows of pixels and between 1280 and 1600 columns of pixels. Note that more or less pixels may be used. Depending upon the lenses used, this represents a first field of view A having a horizontal angle of 70 degrees and a vertical angle of 135 degrees, for example, which represents an aspect ratio of about 9:16.

The image processor 30 creates the back-up second image 52 so that it corresponds to a second field of view B cropped from the lowest portion of the first field of view A. The second field of view B has the same horizontal angle H as the first field of view A. Thus, when looking at the image sensor 14 of the first trailer camera 12 as shown in FIG. 4, the back-up second image 52 corresponds to a subset of the pixels of the image sensor 14 that are the lowest portion of the image sensor 14. The back-up second image 52 may thus be read from lowermost 1024 rows of pixels spanning the 1280 to 1600 columns of pixels. Depending upon lenses used in the first trailer camera 12, this may represent a second field of view B having a horizontal angle of 70 degrees and a vertical angle of 67 degrees, for example, which represents an aspect ratio of about 1:1 or 7:10 (about 70×100 degrees) so one can see from the trailer bumper to above the horizon. In the latter case, more than 1024 rows (about 1700 rows) could be used. However, in this case, if the image is displayed in a rearview display in the same format, the result is an image that is small and difficult to see. Since the rearview display may have a picture-in-picture area that is wider than tall and the image to display is taller than wide, an aspheric distortion to the image may be performed to make the lower area (which is only viewing the road) compressed vertically and the upper section (which sees objects like cars or people) undistorted. This can be thought of as what it would look like if you took an aspheric outside mirror and rotated it 90 degrees. This allows for a larger picture in picture view (as shown in FIG. 4). The rearward third image 55 may be read from about 300 rows in the top half of the image sensor across all the 1280 to 1600 columns of pixels. Depending upon lenses used in the first trailer camera 12, this may represent a third field of view C having a horizontal angle of 70 degrees and a vertical angle of 15 degrees, for example, which represents an aspect ratio of at least about 4:1. Thus, the rearward third image 55 corresponding to a third field of view C is cropped from a portion of the first field of view above the lowest portion, and the third field of view C has a horizontal angle and a vertical angle where the horizontal angle is greater than the vertical angle.

A second trailer camera 12a may be mounted to capture forward images. Similar to the first trailer camera 12, the second trailer camera 12a may be mounted so that it captures images from a field of view having a horizontal angle and a vertical angle where the vertical angle is greater than the horizontal angle where the field of view has an aspect ratio of about 9:16. The image processor 30 may likewise crop the first images received from the second trailer camera 12a into a second image and a third image, where the second image is of a lower field of view encompassing the trailer hitch and the third image is of a higher field of view forward at and/or above the vehicle 25. For example, the third image may be of the bed of a truck that is pulling the trailer 15.

The trailer cameras 12 and 12a may be coupled to the image processor 30 by wired or wireless connection 13 and 13a, respectively. The image processor 30 may be located in the one or both of the cameras 12 and 12a, which may be coupled to the display 40 by wired or wireless connection. By including the image processor 30 in one of the cameras and wirelessly transmitting the images to the display, the transmitted bandwidth may be reduced by a factor of about 90:1 versus having the camera wirelessly communicate with the image processor 30. The image processor 30 may alternatively be co-located with the display 40 in the vehicle 25. The image processor 30 may select the images from the second camera 12a when the vehicle 25 is not coupled to the trailer 15 and the vehicle is backing up while within range for wireless communication with the second trailer camera 12a. Then, when the vehicle 25 and the trailer 15 are coupled, the image processor 30 may select the images from the first trailer camera 12 and may otherwise select to process images from vehicle camera(s) 20 for display on the display 40 when the vehicle 25 is not coupled to the trailer 15 and not within range for wireless communication with the trailer cameras 12, 12a.

The display 40 may be configured for mounting within a rearview assembly mounted to one of a roof and a windshield of the vehicle 25. Thus, the display 40 may serve as a replacement or supplement to an internal rearview mirror. The display 40 could also be provided anywhere else in the vehicle such as in a center stack of an instrument panel.

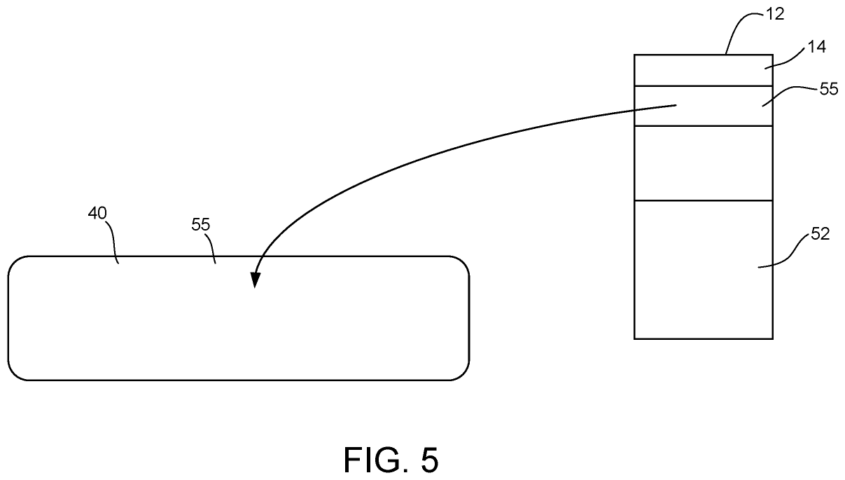

The image processor 30 may receive an input indicating whether the vehicle is in a reverse gear. When the vehicle 25 is not in reverse, the image processor 30 may only read the rearward third image 55 from the image sensor 14 of the first trailer camera 12 and formats the rearward third image for display across the entire display 40 as shown in FIG. 5. However, when the vehicle 25 is in reverse, the image processor 30 reads both the rearward third image 55 and the back-up second image 52 from the image sensor 14 and formats the two images in a side-by-side, or picture-in-picture format for simultaneous display on the display 40 as shown in FIG. 4. This allows the driver to view the back-up second image 52 from the second field of view B near the bumper of the trailer 15 and the rearward third image 52 that is from the third field of view C above the second field of view B. If only the back-up second image 52 were shown, the view would not show objects at any distance, whereas if only the rearward third image 55 were shown, the driver would not be able to see objects close to the back of the trailer 15. It is also possible to configure the image processor 30 to receive an input from a user input that allows a driver to select which images to display on display 40. Although a reverse gear input is described as one input to the image processor 30, various other signals could be used to trigger a change in what is displayed on display 40. For example, inputs could be received from an ultrasonic backup signal, a user button, or a vehicle speed (in which case the back-up second image 52 and the rearward third image 55 may be simultaneously displayed when the vehicle is traveling at a low speed). Although the second image 52 is shown on the right side of first image 55 in FIG. 4, it will be appreciated that the second image 52 may be provided on either side of first image 55.

Although the above description pertains to trailer cameras 12 and 12a, one or more of the vehicle cameras 20 may be mounted such that it captures first images from a field of view having a horizontal angle and a vertical angle where the vertical angle is greater than the horizontal angle where the field of view has an aspect ratio of about 9:16. The image processor 30 may likewise crop the first images received from the vehicle camera 20 into a second image and a third image, where the second image is of a lower field of view encompassing either a hitch mounted to the vehicle 25 or a bed of the vehicle 25, and the third image is of a higher field of view such as rearward of the vehicle 25, for example. The image processor 30 may select either one or both of the second and third images for display on the display 40 depending on an input received by the image processor 30 (i.e., vehicle gear, vehicle speed, user input, ultrasonic back-up signal, etc.)

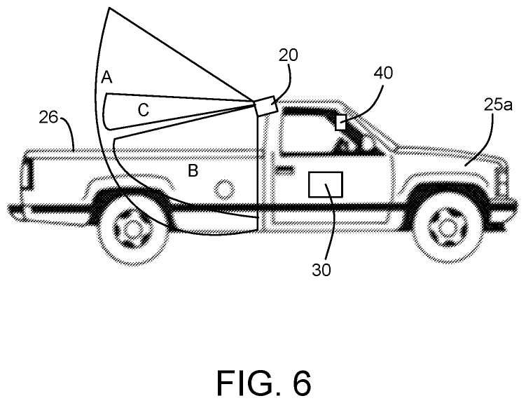

Another example of a vehicle camera 20 used on a vehicle is shown in FIG. 6, where the vehicle is a pickup truck 25a having a truck bed 26 and the camera 20 is mounted proximate the back of the cab of the pickup truck (e.g., in the CHMSL/cargo light fixture) such that the camera 20 is oriented to receive images from a first field of view A having a horizontal angle and a vertical angle where the vertical angle is greater than the horizontal angle. For example, the horizontal angle of the first field of view A may be about 70 degrees and the vertical angle of the first field of view A may be about 135 degrees. This would provide an aspect ratio of about 9:16. The image processor 30 receives images from the camera 20 and processes the images to create a truck bed image and a rearward image from an image captured by the camera 20, the truck bed image corresponding to a second field of view B cropped from the lowest portion of the first field of view A and the rearward image corresponding to a third field of view C cropped from a portion of the first field of view A above the lowest portion, the third field of view C having a horizontal angle and a vertical angle where the horizontal angle is greater than the vertical angle. The display 40 is mounted in the truck 25a and is coupled to the image processor 30 for displaying at least one of the rearward image, the truck bed image, and both the rearward and truck bed images. The horizontal angle of the second field of view may be about 70 degrees and the vertical angle of the second field of view may be about 67 degrees. The aspect ratio of the second field of view may be about 1:1. The horizontal angle of the third field of view may be about 70 degrees and the vertical angle of the third field of view may be about 15 degrees. The aspect ratio of the third field of view may be at least about 4:1.

By providing an imaging and display system that reads two non-contiguous images from a single camera, the system may use a single camera where two cameras would otherwise be provided.

It should further be noted that camera 12 and/or 12a (or an additional camera) may be provided inside or outside of the trailer 15 to capture images inside the trailer or outside the trailer. If provided inside the trailer, the cargo (e.g., livestock) may be monitored. Further, the trailer camera(s) may be powered by the trailer (or other batteries) and repurposed to be used as security camera(s) for monitoring the area around and inside the trailer 15. Video may be streamed and/or recorded for real-time or subsequent viewing on display 40 or on a user's phone.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. An imaging and display system for use in a vehicle pulling a trailer, the system comprising:
a trailer camera mounted on the trailer such that the trailer camera is oriented to receive images from a first field of view having a horizontal angle and a vertical angle where the vertical angle is greater than the horizontal angle;
an image processor for receiving images from the trailer camera and for processing the images to create a back-up image and a rearward image from an image captured by the trailer camera, the back-up image corresponding to a second field of view cropped from the lowest portion of the first field of view and the rearward image corresponding to a third field of view cropped from a portion of the first field of view above the lowest portion, the third field of view having a horizontal angle and a vertical angle where the horizontal angle is greater than the vertical angle; and
a display mounted in the vehicle and coupled to the image processor for displaying at least one of the rearward image, the back-up image, and both the rearward and back-up images.

2. The imaging and display system of claim 1, wherein the trailer camera is configured to wirelessly transmit images to the vehicle.

3. The imaging and display system of any one of claims 1 and 2, wherein the horizontal angle of the first field of view is about 70 degrees and the vertical angle of the first field of view is about 135 degrees.

4. The imaging and display system of any one of claims 1-3, wherein the aspect ratio of the first field of view is about 9:16.

5. The imaging and display system of any one of claims 1-4, wherein the horizontal angle of the second field of view is about 70 degrees and the vertical angle of the second field of view is about 67 degrees.

6. The imaging and display system of any one of claims 1-5, wherein the aspect ratio of the second field of view is about 1:1.

7. The imaging and display system of any one of claims 1-6, wherein the horizontal angle of the third field of view is about 70 degrees and the vertical angle of the third field of view is about 15 degrees.

8. The imaging and display system of any one of claims 1-7, wherein the aspect ratio of the third field of view is at least about 4:1.

9. The imaging and display system of any one of claims 1-8, wherein the display is mounted in a rearview assembly mounted to one of a windshield and a roof of the vehicle.

10. The imaging and display system of any one of claims 1-9, wherein the image processor controls the display to display both the rearward image and the back-up image when the vehicle is in reverse gear, and to display the rearward image when the vehicle is not in reverse gear.

11. An imaging and display system for a vehicle, the system comprising:
a camera mounted such that the camera is oriented to receive first images from a first field of view having a horizontal angle and a vertical;
an image processor for receiving the first images from the camera and for processing the first images to create a second image and a third image from a first image captured by the camera, the second image corresponding to a second field of view cropped from a lower portion of the first field of view and the third image corresponding to a third field of view cropped from a portion of the first field of view above the lower portion; and
a display mounted in the vehicle and coupled to the image processor for simultaneously displaying both the second and third images.

12. The imaging and display system of claim 11, wherein the camera is a trailer camera that is configured to wirelessly transmit images to the vehicle.

13. The imaging and display system of claim 11, wherein the vehicle is a pickup truck having a truck bed and the third images are rearward images.

14. The imaging and display system any one of claims 11-13, wherein the second images are truck bed images.

15. The imaging and display system of any one of claims 11-14, wherein the horizontal angle of the first field of view is about 70 degrees and the vertical angle of the first field of view is about 135 degrees.

16. An imaging and display system for a pickup truck having a truck bed, the system comprising:
a camera mounted on the truck such that the camera is oriented to receive images from a first field of view having a horizontal angle and a vertical angle where the vertical angle is greater than the horizontal angle;
an image processor for receiving images from the camera and for processing the images to create a truck bed image and a rearward image from an image captured by the camera, the truck bed image corresponding to a second field of view cropped from the lowest portion of the first field of view and the rearward image corresponding to a third field of view cropped from a portion of the first field of view above the lowest portion, the third field of view having a horizontal angle and a vertical angle where the horizontal angle is greater than the vertical angle; and
a display mounted in the truck and coupled to the image processor for displaying at least one of the rearward image, the truck bed image, and both the rearward and truck bed images.

17. The imaging and display system of claim 16, wherein the horizontal angle of the first field of view is about 70 degrees and the vertical angle of the first field of view is about 135 degrees.

18. The imaging and display system of any one of claims 16 and 17, wherein the aspect ratio of the first field of view is about 9:16.

19. The imaging and display system of any one of claims 16-18, wherein the aspect ratio of the second field of view is about 1:1.

20. The imaging and display system of any one of claims 16-19, wherein the horizontal angle of the third field of view is about 70 degrees and the vertical angle of the third field of view is about 15 degrees.
